(19) United States
(12) Patent Application Publication
(10) Pub. No.: US 2021/0407026 A1
(43) Pub. Date: Dec. 30, 2021

(54) HYBRID LEARNING EDUCATION MODEL (HLEM)

(71) Applicants: Francis Joseph Chowalloor, Mumbai (IN); Husien Dohadwalla, Mumbai (IN); Reuben Francis Chowalloor, Mumbai (IN)

(72) Inventors: Francis Joseph Chowalloor, Mumbai (IN); Husien Dohadwalla, Mumbai (IN); Reuben Francis Chowalloor, Mumbai (IN)

(21) Appl. No.: 17/468,955

(22) Filed: Sep. 8, 2021

(51) Int. Cl. G06Q 50/20; G09B 19/00; G09B 5/02

(52) U.S. Cl. CPC G06Q 50/205; G09B 5/02; G09B 19/00

(57) ABSTRACT

The Hybrid Learning Education Model (HLEM) is provided with an objective to ensure that learning is accessible, affordable, inclusive, developmental to educate learners beyond boundaries. Over many decades, teaching and learning was largely restricted to physical schools purely through face-to-face learning. The COVID-19 pandemic & subsequent lockdowns totally disrupted teaching & learning due to school closures announced by all countries globally. Technology in classroom was seen as one of the supplementary learning tools in education. Physical Schools and educational institutions held governance of student teaching & learning. Home schooling was seen in the dim light of educational progress towards sustenance. While Design Learning (DL) and outcome-based approach gained prominence, the Design Learning (DL) methods have been comprehensively used in various regions, there by assisting in teaching, learning, evaluation, and outcome-based assessment. In this advancement, we present an outline of the HLEM through Parent campus and Home Campuses, essentially looking at it from a origin, initiation, screening and assessment perspectives.

### FIELD OF THE INVENTION

Our Invention is related to Hybrid Learning Education Model (HLEM).

### BACKGROUND OF THE INVENTION

Our development is to share about the Hybrid Learning Education Model which I, Francis Joseph Chowalloor has created alongside my partner Hussain Dohadwalla and my son Reuben Francis, so the crossover learning schooling model spotlights on two components which is the first being the face to face in-person learning and the subsequent one is the web based online learning.

During the pandemic, schools for more than 168 million children globally have been completely closed for almost an entire year due to COVID-19 lockdowns (UNICEF) and the teaching-learning process was moved 100% online with no face-to-face in-person learning happening since the schools were shut, to avoid the spread of Covid. The school closures have had devastating consequences for children's learning and wellbeing, with huge learning gaps observed among young students. This inspired us to create a Hybrid Learning Education Model, which integrates both face-to-face in-person learning, and web based online learning utilizing innovation & scale, through parent and home campuses with an objective to ensure scale.

In the coming months we are experiencing that schools are being allowed to reopen (subject to several covid protocols such as staggered timetables, lesser students in a classroom etc. . . . ) and is heavily dependent on the rise of covid cases in the city/district/state/country. There are countries/states where schools had to be closed again after being allowed to reopen. In these circumstances, regardless of whether everything becomes “normal” or “new normal”, we strongly recommend that schools/college and education boards/universities should adopt the Hybrid Learning Education Model (HLEM) where teaching & learning happens both through online using web-based technologies and face-to-face in-person in in physical schools/colleges or independent learning centers. This will also allow institutions to quickly switch to remote learning as and when needed. Subjects can be taught using both these components. Teaching & learning can start online and then it can go to face-to face learning in parent campus/home campuses and then it can return to online and further. What matters finally is the achievement of the learning objectives, but there are certain skills & practices that needs to be developed through face-to-face in person learning only such as examinations, laboratory practical's, performing arts, talent and skill development programs such as music, sports, dance and many other activities such as the coursework, doubt clarification by teachers, internship, community service projects, access to resources and materials, competitions and events and many more as outlined in the Hybrid Learning Education Model.

For instance, introduction to the course, on what will be learned and its learning objectives can begin with face-to-face learning, after which the students can view video clips of teaching materials, assignments through online learning at one's own pace, followed by discussions, interactions, doubt clarifications done through face-to-face learning, afterward return to more deeper learning, assessment, and research done online, finally followed by presentation done through face-to-face learning. Certain subjects can also be taught totally online or totally face-to-face depending on the availability of the resource and learning objectives of the subject. What finally matters is the accomplishment of the learning objectives.

Through the HLEM online learning, students can have access to the e-library, virtual laboratories, participate in online competitions & events, career & behavioural counselling, continuous assessment, participate in intercultural and collaborative projects with other home campuses/learning centres, e-sports and participate in virtual internship.

A student adopting the Hybrid Learning Education Model is a student who wants to leverage the advantage of both face-to-face and online learning allowing self-paced and differentiation in his/her own individual learning style. The Hybrid Learning Education Model helps in enabling us to improve & scale the access of education to even remote areas of the country/in the world, since the model is not heavily dependent on a huge physical school building, as a parent/home campus can be smaller school spaces or learning centres with key deliverables as defined in the model. The model aims at providing education through quality teachers from across boundaries at a much affordable fee to the learners/students with high flexibility to a student through this education model

The occasions now these exercises must be led vis-à-vis and they ought to in the Hybrid Learning Education Model. They are led vis-à-vis in the online learning model we have understudies to gain admittance to the library, they gain admittance to virtual research centers, for them partake in online rivalries and occasions they additionally get vocation directing, the kids are consistently surveyed in on the web.

Always keeping in mind that they likewise lead intercultural and community service projects between different schools, conduct guiding additionally can happen on the web and they can take part in sports and furthermore take part in virtual entry level position. Presently a common understudy joining the cross breed learning training model is an understudy who needs to use the benefit of both face-to-face learning.

The web and that is the sort of understudy that is the kind of student we are searching for this the mixture learning instruction models help in empowering us to work on the entrance of training to even far off spaces of the country on the planet so access is a major significant factor here since we are not vigorously relying upon the blocks and concrete or the structure of the school and the cost can the expense construction can be more moderate to the understudies so smashing down the reasonableness and working on the moderateness of schooling lastly is the adaptability that a youngster can get past this schooling model.

So the mixture instruction learning model can be embraced by training sheets they can be taken on by schools and a specific school as a parent campus can really offer the half and half taking in training model to understudies from any part of the world, the kid can benefit both instruction by means of the parent campus and through the home campuses/learning centres to guarantee the all-out consummation of the cycle the home campuses could be neighborhood schools/colleges who might uphold all the vis-à-vis and face-to-face in person learning and the parent campuses will deal with the entire cross breed learning instruction model for every one of the students/learners.

So the core of the mixture learning schooling model is the entire model is disseminated in to vis-à-vis face-to-face in-person learning and online learning and both have their equivalent number of components which they offer and together they become a piece of the crossover learning training model the subsequent perspective is the scale how would you really work this entire model for which you need a parent campus who takes the sole authority of dealing with the entire half and half learning instruction model through straightforwardly there campus or through home campuses which are altogether lawful substances which can deal with the entire model.

In order to ensure that accountability, transparency, and local regulations are met, the Hybrid Learning Education Model incorporates the role of parent campus and home campuses/learning centres with an aim to reach scale and access to students across the planet. The Hybrid Learning Education Model (HLEM) can be adopted by education boards/universities/schools/colleges with a particular school/college entity as a parent campus who will lead the hybrid learning education model to students from any part of the world. The student can avail both education via the parent campus and via the home campuses/learning centres to ensure the total completion of the cycle, which included face-to-face in-person and online learning. The home campuses could be local schools/physical learning centres who would manage and support all the face-to-face in-person learning of the model and the parent campus will be managing the whole hybrid learning education model for all the learners including online learning.

### Objectives of the Invention

The target of the development is to guarantee availability to quality instruction across location, strata, area, moderateness and learning backing to understudies at present being self-taught and for those understudies looking for adaptability and separation in the manner they learn rather than the proper training in an actual school just through face-to-face in-person learning.

2. The other target of the development is to give admittance to quality educators universally.

3. The other target is to cover the learning gaps/misfortune caused because of web based 100% totally online, adapted uniquely during the time of pandemic.

4. The other target of the creation is to guarantee that adapting and learning never stops regardless of whether we are confronted with a future pandemic, epidemic or scourge.

5. The other goal of the creation is to rely less upon the expense of physical brick-and-mortar physical infrastructure and actual offices accessible in the school consequently expanding the expense of instruction, teaching & learning brought about by the public and non-public schools/colleges.

### SUMMARY OF THE INVENTION

We present a broad outline of the HLEM computations and model that can be used on this endeavor and help with battling the learning loss Educational Institutions are striving hard to bring about a change in the learning situation with a panoramic view point.

While Design Learning (DL) strategies have been used as a learning strategy, the HLEM model aims ensuring accessibility for the most part used in various spaces, there is by and by a fame for DL-helped investigation systems for screening, following, and expecting the spread of COVID-19 and finding a fix against it. In this creation, we present an outing of which work DL has played so far in battling the contamination, on a very basic level looking at it from a screening, checking, and counter acting agent perspectives.

We present a thorough audit of the DL estimations and models that can be used on this mission and help with drawing in the disease. Record Terms—COVID-19, Design Learning, Artificial Intelligence, Healthcare, Drug Development, Prevention, Predictive Analysis, Diagnosis, Image Classification.

Thus, the crossover model is currently used to enhance numerous answers for understudy achievement. In certain schools, this implies having understudies at home low maintenance and in class low maintenance; different regions have decided to keep certain grade bunches home full time and permit more youthful kids to return face to face.

The mixed adapting frequently appears as new drives, for example, project-based discovering that add interactive media assets to normal coursework and permit understudies to self-direct a portion of their figuring out how to investigate the comprehensive consequences of contrasting instructive teaches like math, science or math and sciences.

Mixture classes, in the interim, take these online devices and give them to understudies through distant learning entryways and internet learning the board frameworks for use outside of the customary school climate.

With regards to divided learning versus mixed learning, here's a decent general guideline: If instruments increase up close and personal structures, they're mixed learning models. In the event that they work with the substitution of face-to-face in-person guidance, they're crossover/HLEM.

Late examination from the Economic Policy Institute recommends that web based educating and learning models can be successful “if students have steady admittance to the Internet and PCs and if educators have got designated in preparing and upholding for online guidance.”

Truth be told, probably the greatest trouble spots that have arisen have less to do with the innovation used to work with far off learning and crossover learning itself and more to do with tech-tested instructors entrusted with utilizing that innovation.

The preparation and backing they need is basic, and it's not only for the actual product. How would they make exercise plans under this new model? How would they help students who are battling? What happens when the product falls flat?”

In any case, that in-school Wi-Fi isn't sufficient to make compelling crossover/HLEM learning plans in light of the fact that numerous families need admittance to dependable broadband web at home.

As schools plan for an expected re-visitation of the study hall in fall 2021, a few components of crossover learning/HLEM will remain. This could appear as families deciding on home schooling as an outcome until the normal schooling rollout arrive at a specific edge or schools picking a to some extent crossover model to lessen stuffing of knowledge and work on one-on-one communication.

That is the reason educators should accept the mixture learning shift as a central change to be assimilated and carried out into the more extensive arrangement and vision for the fate of schooling.

While we noticed that this methodology isn't without its difficulties, given “the numerous intangibles that we can't place and the requirement for the right blend of assets, preparing and imaginative personalities and accepts that mixture learning can have a positive effect in case it's at the bleeding edge of instructive change.

The History and Evolution of Distance Learning The act of conventional instruction framework, in which the educator and the student are absent simultaneously and spot, is accepted to have started at some point toward the finish of 1800s.

The idea of distance taking in potentially begins from this thought. Correspondence between the educator and the student was led through letters; the utilization of mail to convey course materials addresses the original of distance instruction that utilizes correspondence in advanced education.

The method for correspondence conveyed in correspondence schooling changed over the long haul. For example, during the 1930s, the letter was utilized alongside the radio, and during the 1950s, the TV.

This advancement proceeded with the improvement of innovation. The moment and simple sending of data to the distant student was made conceivable by the approach of intuitive TV in the mid-1990s, and during the 1990s, by the advancement of shut circuit TV, microwave transmission, video recording, and satellite transmission content.

Because of these turns of events, students from various topographical locales can now more effectively speak with one another and with their instructors, either simultaneously or no concurrently, to work with admittance to information.

Quick innovative changes have additionally made the transmission of content as designs, pictures, sound, reproduction, face-to-face correspondence, etc, among educators and students conceivable.

On account of the remote insurgency in the last part of the 1990s, which brought about a significant development of gadgets like workstations, cell phones, and individual advanced collaborators, the course of distance taking in has gotten free from time and location.

Obviously, distance training has a long history that happens close by the improvement of innovation. Various method for distance training have developed alongside various innovative changes. As of now, interchanges frameworks through PC present a considerably more complex method for distance instruction.

### BRIEF DESCRIPTION OF THE DIAGRAM

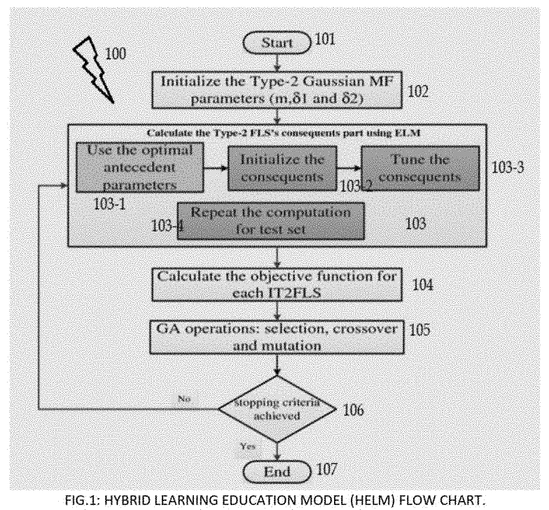

FIG. 1: Hybrid Learning Education Model (HELM) Flow Chart.

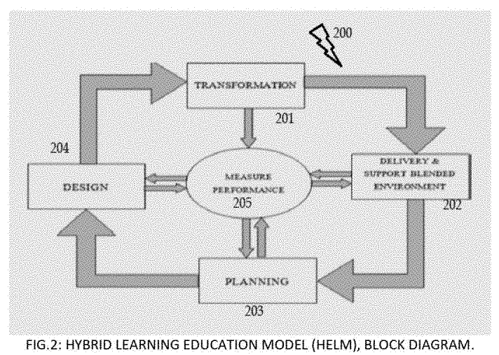

FIG. 2: Hybrid Learning Education Model (HELM), Block Diagram.

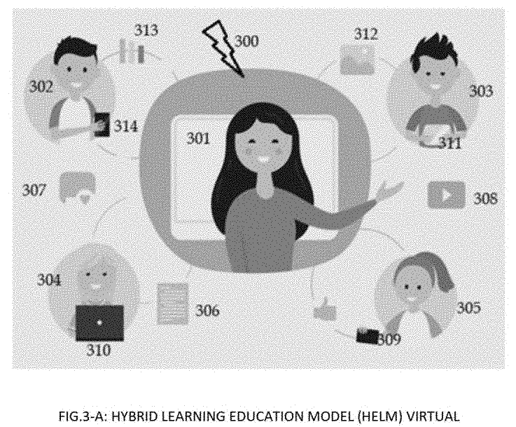

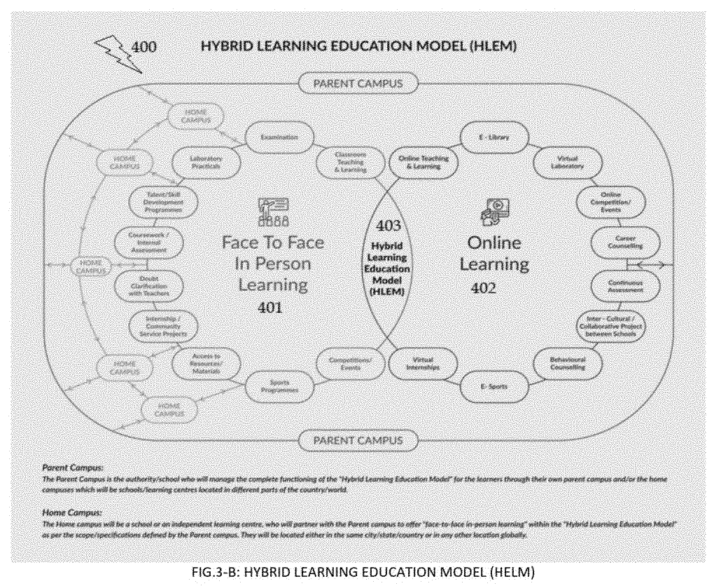

FIG. 3-A: Hybrid Learning Education Model (HELM) Virtual.

FIG. 3-B: Hybrid Learning Education Model (HELM)

### DESCRIPTION OF THE INVENTION

The investigation of the information gathered displayed there are various obstructions that face the schools in India & world to execute the distance learning, likewise, the outcome showed the by and large uplifting perspective among scholastic staff from carrying out the distance learning in the schools.

At long last, the outcomes raised some significant issues that ought to be thought about while carrying out the distance learning in the schools later on. The outcomes answer the inquiries as follow:

Hindrances that Affect Adoption of Distance Learning in Indian Education Boards zeroed in on the significant issues to decide the obstructions and ICT circumstance in the available society and home.

The inquiries applicable to the object of this examination were asked to the respondents. The outcomes show that the Internet administration given by the school is insufficient and innovation upgraded offices are inadequate.

Moreover, the Education Boards has no connection with one advanced education organization, and there is no genuine key arrangement has been embraced by the school to give distance schooling later, likewise, there is an absence of divided vision between the respondents to execute the distance learning.

The outcome shows the availability of utilizing ICT in instructing, and the scholarly staff utilized the data and correspondence innovation to associate with students, partners and school organization. Furthermore, the majority of the scholarly staff have experience utilizing the PC programming like MS Windows, MS office and the Internet too.

Likewise, a large portion of the members have Internet association in their home. Plus, the outcome presents that the execution of distance learning will tackle the issues of expanding quantities of students at advanced education area. Truth be told, it will likewise give the adaptable learning climate to students.

The members have accomplished a specific mindfulness with respect to the upsides of distance training idea lately. All the while, there is a positive view from the members toward execution of distance training idea too.

The outcome additionally shows that there is an acknowledgment level of commitment from the staff with respect to execution of HLEM framework in the schools. Due to a few reasons and benefits, that distance instruction will give, for example, “give the adaptable schooling climate”, “give freedoms to general students”, “cost decrease”, “permitting wedded students”, “working students” and “students from far off region” to admittance to the ideal training.

Any initial phase in a HLEM project in IHE should begin from a mixing of learning strategies. Such a mix guarantees that the objective is reached in a not so much expensive but rather more powerful way, paying little mind to the learning institution's strength and level of innovation.

To push ahead from the conventional course to the distance adapting course is a complicated interaction that requires arranging and an execution method. Based on the writing audit and the overview.

Statement of purpose The schools with low take-up of ICT that longing to carry out the distance schooling ought to propose a statement of purpose and give the important guidelines and guideline to foster a virtual ground to give distance learning freedoms to understudies who face exceptional conditions to go to customary colleges.

### Distance Learning Focuses

To start in executing the distance schooling idea in the schools, the distance instruction focuses ought to be set up. The schools should begin to set up and make two data and correspondence focuses to control and straightforwardly direct the execution of distance instruction and the arrangement of a proper climate.

A PC community entrusted with making both the actual foundation like PCs, workers and data transmission, and the required programming like LMS, site and MIS, ought to be made.

A unique community for assessing its use and learning innovations in distance instruction ought to likewise be built. 3) ICT Infrastructure Information and Communication Technologies (ICT) can discover adaptable learning technique.

The schools with low take-up the ICT should start to advance the utilization of ICT in schools to empower the use of distance schooling in instruction and preparing.

### Awareness

To push ahead in applying distance training project, there is a need to raise the mindfulness among senior work force and executives of the MHIs and the colleges about the need to begin to carry out the distance schooling program and the advantage that will be acquire for the understudies and the scholastic staffs from carry out such program.

Plan Success in a distance learning climate includes a deliberate course of preparation, planning, assessing, and carrying out. In the HELM model the plan measures center around how to decipher the conventional and e-learning draws near. The consolidation of e-learning in customary learning is executed step by step. The plan is focused on four ideas.

1. A method of working of a Hybrid Learning Education Model (HLEM) for covid spread prevention to a students using design learning is comprising steps of:
providing a hybrid education system for combined online and face-to-face learning;
providing a parent campus for handling the whole HELM model including online and face-to-face learning;
providing a home campus for face to face learning;
allowing the students to begin with first the face-to-face learning;
allowing the students to view a video clips of a teaching material, assignments through online learning;
followed by discussion, interactions, and doubt clarifications through face-to-face learning;
allowing to have deeper learning, assessment and research done online; and
finally by presentation done through face-to-face learning.

2. The method of working of a Hybrid Learning Education Model (HLEM) of claim 1, wherein the home campus may be any of local schools or physical learning centers which are capable of managing and supporting all the face-to-face and in-person learning of the HLEM.

3. The method of working of a Hybrid Learning Education Model (HLEM) of claim 1, wherein the HLEM using the parent campus and home campus aims to reach scale and access to the students across the planet.

4. The method of working of a Hybrid Learning Education Model (HLEM) of claim 1, wherein the HLEM provides an access to an e-library, virtual laboratories, online competitions and events, career and behavioral counselling, continuous assessment, intercultural and collaborative projects and participation in virtual internship.
